(19) United States
(12) Patent Application Publication
(10) Pub. No.: US 2016/0303798 A1
(43) Pub. Date: Oct. 20, 2016

(54) METHOD AND DEVICE FOR MANUFACTURING OF THREE DIMENSIONAL OBJECTS UTILIZING DIRECT PLASMA ARC

(71) Applicant: UNITED TECHNOLOGIES CORPORATION, Farmington, CT (US)

(72) Inventors: Sergey Mironets, Charlotte, NC (US); Agnes Klucha, Shelburne, VA (US)

(73) Assignee: UNITED TECHNOLOGIES CORPORATION, Farmington, CT (US)

(21) Appl. No.: 15/102,249

(22) PCT Filed: Dec. 5, 2014
(86) PCT No.: PCT/US2014/068849

§ 371 Date: Jun. 6, 2016

Related U.S. Application Data
(60) Provisional application No. 61/919,182, filed on Dec. 20, 2013.

(51) Int. Cl. B29C 67/00; B33Y 30/00; B33Y 50/02; B33Y 80/00; F01D 5/28; B23K 28/00; B22F 3/105; B22F 5/00; B28B 1/00; B28B 17/00; B33Y 10/00; H05B 3/00

(52) U.S. Cl. CPC B29C 67/0077; B33Y 10/00; B33Y 30/00; B33Y 50/02; B33Y 80/00; H05B 3/0061; H05B 3/0057; B23K 28/00; B22F 3/1055; B22F 5/009; B29C 67/0088; B29C 67/0092; B28B 1/001; B28B 17/0081; F01D 5/28; B22F 2003/1057; B22F 2998/10; B29L 2031/085

(57) ABSTRACT

A method of forming a component includes preparing a starting powder and spreading the powder on a platform to form a first layer. A first mask with a plurality of openings is placed over the platform and the platform is irradiated with an energy source, such that the energy passes through the openings in the mask and transforms selected regions of the first layer into a denser form of matter according to a 3-D model of the component stored in a control system of the device. The platform is then indexed down one layer of thickness and a second layer of powder is spread on the first layer. A second mask with a plurality of openings is positioned between the energy source and the first layer and the first layer is irradiated with energy that passes through the mask and transforms selected regions of the second layer into a denser form of matter. The platform is indexed down one layer of thickness again and the process repeated until the component is formed.

### BACKGROUND

This invention relates to forming components by additive manufacturing. In particular, the invention relates to methods of densifying each layer in a layer-by-layer build process.

Additive manufacturing is a process by which parts can be made in a layer-by-layer fashion by machines that create each layer according to an exact three dimensional (3-D) computer model of the part. In powder bed additive manufacturing, a layer of powder is spread on a platform and selective areas are joined by sintering or melting by a directed energy beam. The platform is indexed down, another layer of powder is applied, and selected areas are again joined. The process is repeated for up to thousands of times until a finished 3-D part is produced. In direct deposit additive manufacturing technology, small amounts of molten or solid material are applied to a platform according to a 3-D model of a part by extrusion, injection or wire feed and energized by an energy beam to bond the material to form a part. Common additive manufacturing processes include selective laser sintering, direct laser melting and electron beam melting.

Since a part is produced in a continuous process in an additive manufacturing operation, features associated with conventional manufacturing processes such as machining, forging, welding, casting, etc. can be eliminated leading to savings and cost, material and time.

Early additive manufacturing products were used, for instance, for 3-D design concepts, rapid prototyping of models, and other applications. In the past decade, interest has been growing in the direct fabrication of useful parts across industry. Specifically, interest is growing in accelerating the layer-by-layer build process to decrease manufacturing time.

### SUMMARY

A method of forming a component includes preparing a starting powder and spreading the powder on a platform to form a first layer. A first mask with a plurality of openings is placed over the platform and the platform is irradiated with an energy source, such that the energy passes through the openings in the mask and transforms selected regions of the first layer into a denser form of matter according to a 3-D model of the component stored in a control system of the device. The platform is then indexed down one layer of thickness and a second layer of powder is spread on the first layer. A second mask with a plurality of openings is positioned between the energy source and the first layer and the first layer is irradiated with energy that passes through the mask and transforms selected regions of the second layer into a denser form of matter. The platform is indexed down one layer of thickness again and the process repeated until the component is formed.

In an embodiment, an apparatus to form a component by layer-by-layer manufacturing includes a 3-D computer model of the component stored in a central control system, a powder source, a moveable platform, and a fixture to spread a layer of powder from a powder source onto the moveable platform. A stationary directed energy source to irradiate the entire area of the platform and a mask between the energy source and the platform are also included. The mask has a plurality of openings according to cross-sections of the component in the 3-D computer model that allows energy to pass through the openings and transform specific areas of the powder layer to be transformed into a denser form of matter. The platform is moved down during the build by a linear actuator mechanism. The apparatus is encased in an atmosphere controlled chamber.

### BRIEF DESCRIPTION OF THE DRAWINGS

FIG. 1 is a schematic representation of an additive manufacturing process incorporating the invention.

FIG. 2 is a top view of a masking foil showing two features of the tape.

### DETAILED DESCRIPTION

Additive manufacturing is a process wherein three-dimensional (3-D) objects are produced with a layer-by-layer technique directly from a digital model. The additive manufacturing process is in distinct contrast to conventional subtractive methods of manufacturing wherein material is removed in a piece-by-piece fashion from a blank by machining, grinding, etc. or by other forming methods such as forging, casting, injection molding, etc. In additive manufacturing, a piece is formed by the deposition of successive layers of material with each layer adhering to the previous layer until the build is completed. A single layer may be formed by sintering, fusing, or otherwise densifying specific areas of the top surface of a powder bed or a polymerizable liquid by a computer controlled beam of energy or by depositing individual liquid or semi-solid drops of a material on specific areas of a work piece by a computer controlled deposition apparatus. Common energy sources are laser and electron beams.

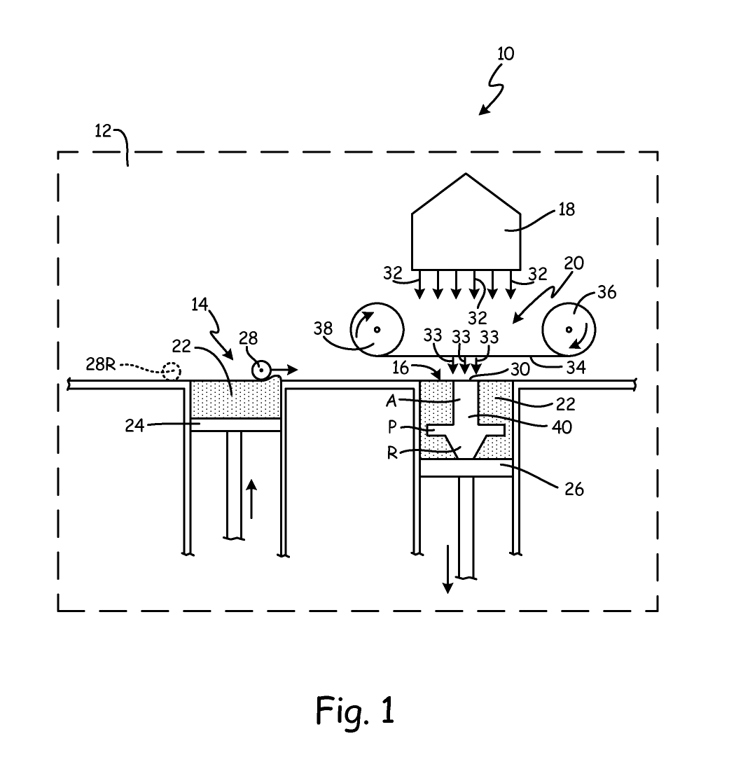

An example of a powder based additive manufacturing process of the invention is shown in FIG. 1. Process 10 includes manufacturing chamber 12 containing devices that produce solid components by additive manufacturing. Process 10 comprises powder storage chamber 14, build chamber 16, directed energy source 18 and masking system 20. Directed energy source 18 may be a source of electromagnetic energy comprising plasma arc energy, UV energy, microwave energy and others known in the art. Manufacturing chamber 12 may be an atmosphere controlled chamber containing an inert gas such as helium, argon or other gasses known in the art.

During operation of process 10, powder 22 is fed upward by piston 24 and is spread over build platform 26 by roller 28. After powder 22 is spread in an even layer on build platform 26, roller 28 returns to A resting position as indicated by phantom roller 28R. Directed energy source 18 is then activated and is capable of irradiating the entire top area of platform 26. Masking foil 34 is situated between directed energy source 18 and build chamber 16 and includes windows that permit only a portion of directed energy 33 to pass through and irradiate selective portions 30 on build platform 26. Top 30 of powder 22 on build platform 26 is densified by energy from energy source 18 that passes through masking foil 34 as indicated by parallel directed energy arrows 33. Masking foil 34 may contain transparent regions to allow directed energy 32 that define selective areas 30 on the top layer of build chamber 16 that are heated by directed energy source 18 and subsequently sintered or fused by directed energy 32. In the example in FIG. 1, selective area 30 is the top of component 40. For illustrative purposes, component 40 may be a turbine component such as a turbine blade comprising a root section R, platform section P and airfoil section A.

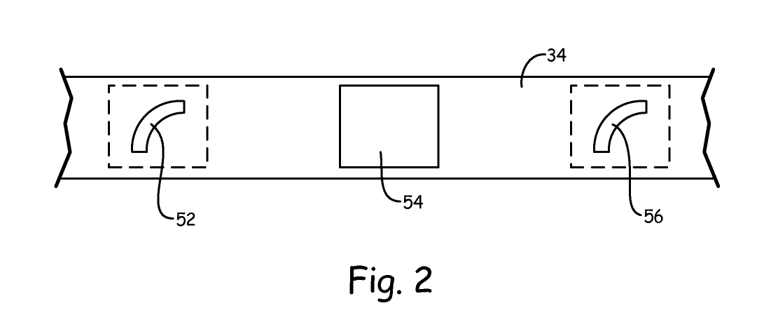

An example of a top view of masking foil 34 is shown in FIG. 2. In the example, masking foil 34 contains three features: transparent areas 52, 54 and 56. Transparent area 52 is an example of an airfoil cross-section. Transparent area 54 is an open frame that allows the entire top surface of build chamber 16 to be entirely illuminated by directed energy source 18 for reasons discussed next. The dotted lines indicate the entire top surface of build chamber 16. Transparent area 56 is the airfoil cross-section of the next layer on top of the present layer and is slightly different than area 54 according to the airfoil curvature.

During a build of exemplary airfoil 36 in build chamber 16, airfoil 36 may be constructed from high temperature alloys. Exemplary alloys may be, but are not limited to, nickel base, iron base, cobalt base superalloys and mixtures thereof and titanium alloys. An untreated layer of the above-mentioned high temperature alloy may need to be preheated before sintering or fusing selected areas. Open frame 38 as shown in FIG. 2 allows preheating of the entire top layer of build chamber 16 by directed energy source 18 for this purpose.

After selected areas of the top layer 16 are sintered or fused, piston 26 moves down one layer of thickness and piston 24 advances and exposes a layer of powder 22 to be spread over build chamber 16. Roller 28 then spreads a layer of powder 22 on build chamber 16. Rollers 36 and 38 advance masking foil 34 to position a new frame over build chamber 34 with transparent and opaque areas that allow directed energy source 18 to illuminate selected areas of the top surface of the build chamber 16 to treat the recently deposited layer of powder. The process is repeated until a component is formed.

Masking foil 34 may be a metal alloy, a woven ceramic/metal composite or another flexible high temperature material known in the art. In other embodiments, foil 34 may comprise a transparent film upon which opaque regions are printed to define the transparent regions. A preferable foil material for high temperature applications may be a very high temperature alloy with a highly reflective surface to resist heating by the direct energy source.

For rapid, high temperature thermal processing of the layers during additive manufacturing, a directed plasma arc energy source is preferred. A directed plasma arc energy source is described in U.S. Pat. No. 7,220,436 to Ott et al.

In another embodiment, lower temperature materials such as polymers or powders coated with polymeric binders may be used to form objects by the single exposure process of this invention. In this case, radiative energies such as UV or other energies known in the art for curing polymers may be employed.

In another embodiment, roller 28 may be replaced by a rigid recoater or other devices known in the art.

The following are non-exclusive descriptions of possible embodiments of the present invention.

A method of forming a component by an additive manufacturing process includes preparing a starting powder; spreading the powder on a platform to form a first layer; positioning a mask over the first layer with an opening in the mask to allow radiative energy from a stationary source to pass through the mask and irradiate a selective region of the first layer and transform the region into a denser form of matter according to a 3-D computer model of the component; indexing the platform down one layer of thickness; spreading a second layer of powder on the platform; positioning a second mask over the layer with an opening in the mask to allow radiative energy from a source to pass through the mask and transform a selective region of the second layer into a denser form of matter according to a 3-D computer model of the components; indexing the platform down one layer of thickness; and repeating the process until the component is formed.

The method of the preceding paragraph can optionally include and/or alternatively any, one or more of the following features, configurations and/or additional components:

The first layer may be preheated by the radiative energy before a mask corresponding to a region to be densified by the radiative energy is placed over the layer.

The radiative energy source may be a directed plasma arc.

The radiative energy source may be a UV lamp.

The component may be formed from polymer, metal, ceramic and composite materials and mixtures thereof.

The metal may comprise a nickel base, iron base, cobalt base superalloy or mixtures thereof.

The component may be a turbine component.

Regions which are transformed into a denser form of matter may be transformed by sintering, melting, solidifying, polymerization or mixtures thereof.

An apparatus to form a component by layer-by-layer additive manufacturing may include: a 3-D computer model of a component stored in a central control system; a powder source; a moveable platform; a fixture to spread a layer from the powder source on the moveable platform; a stationary directed energy source to irradiate the entire area of the platform to densify the powder; a mask between the stationary energy source and powder on the platform with an opening which allows a specific area of the powder to be densified according to the shape of that layer of the component in the 3-D computer model; a mechanism to move the platform down one layer of powder thickness to allow another layer of powder to be applied to the previous layer and be selectively densified by the stationary energy source according to the opening in the mask corresponding to that layer in the 3-D model of the component; and an atmosphere controlled chamber.

The apparatus of the preceding paragraph can optionally include, additionally and/or alternatively any, one or more of the following features, configurations and/or additional components.

The mask may be a moveable foil tape.

The mask may be a moveable foil tape with a plurality of openings corresponding to cross-sections of the component in the 3-D computer model of the component.

The powder may be a metal, ceramic, polymer or mixtures thereof.

The fixture to spread powder may be a roller or a rigid recoater.

The stationary directed energy source may be a directed plasma arc lamp or a UV light source.

The directed energy source may be a directed plasma arc lamp.

The mask may be a metal alloy or a woven ceramic/metal composite.

The openings in the mask may be formed by laser cutting.

The atmosphere may be an inert gas.

The inert gas may be argon or helium.

The mechanism to move the platform may include a mechanical, hydraulic, pneumatic or piezoelectric linear actuator.

Although the present invention has been described with reference to preferred embodiments, workers skilled in the art will recognize that changes may be made in form and detail without departing from the spirit and scope of the invention.

1. A method of forming a component by an additive manufacturing process comprising:
preparing a starting powder;
spreading the powder on a platform to form a first layer;
positioning a mask over the first layer with an opening in the mask to allow radiative energy from a stationary source to pass through the mask and irradiate a selective region of the first layer and transform the regions into a denser form of matter according to a 3-D computer model of the component;
indexing the platform down one layer thickness;
spreading a second layer of powder on the platform;
positioning a second mask over the layer with an opening in the mask to allow radiative energy from a source to pass through the mask and transform a selective region of the second layer into a denser form of matter according to a 3-D computer model of the components;
indexing the platform down one layer of powder thickness; and
repeating the process until the component is formed.

2. The method of claim 1 wherein the first layer is preheated by the radiative energy before a mask corresponding to a region to be densified by the radiative energy is placed over the layer.

3. The method of claim 1 wherein the radiative energy source is a directed plasma arc.

4. The method of claim 1 wherein the radiative energy source is a UV lamp.

5. The method of claim 1 wherein the component is formed from polymer, metal, ceramic and composite materials and mixtures thereof.

6. The method of claim 5 wherein the metal comprises a nickel base, iron base, cobalt base superalloy or mixtures thereof.

7. The method of claim 1 wherein the component is a turbine component.

8. The method of claim 1 wherein regions which are transformed into a denser form of matter are transformed by sintering, melting, solidifying, polymerization or mixtures thereof.

9. An apparatus to form a component by layer-by-layer additive manufacturing comprising:
a 3-D computer model of the component stored in a central control system;
a powder source;
a moveable platform;
a fixture to spread a layer of powder from the powder source on the moveable platform;
a stationary directed energy source to irradiate the entire area of the platform to densify the powder;
a mask between the stationary energy source and powder on the platform with an opening that allows a specific area of the powder to be densified according to the shape of that layer of the component in the 3-D computer model;
a mechanism to move the platform down one layer of powder thickness to allow another layer of powder to be applied to the previous layer and be selectively densified by the stationary energy source according to the opening in the mask corresponding to that layer in the 3-D model of the component; and
an atmosphere controlled chamber.

10. The apparatus of claim 9 wherein the mask is a moveable foil tape.

11. The apparatus of claim 9 wherein the mask is a moveable foil tape with a plurality of openings corresponding to cross-sections of the component in the 3-D computer model of the component.

12. The apparatus of claim 9 wherein the powder is a metal, ceramic, polymer or mixtures thereof.

13. The apparatus of claim 9 wherein the fixture to spread powder is a roller or a rigid recoater.

14. The apparatus of claim 9 wherein the stationary directed energy source is a directed plasma arc lamp or a UV light source.

15. The apparatus of claim 14 wherein the directed energy source is a directed plasma arc lamp.

16. The apparatus of claim 9 wherein the mask is a metal alloy or a woven ceramic/metal composite.

17. The apparatus of claim 9 wherein the openings in the mask are formed by laser cutting.

18. The apparatus of claim 9 wherein the atmosphere comprises an inert gas.

19. The apparatus of claim 18 wherein the inert gas comprises argon or helium.

20. The apparatus of claim 9 wherein the mechanism to move the platform comprises a mechanical, hydraulic, pneumatic, or piezoelectric linear actuator.
